(19) United States
(12) Patent Application Publication
(10) Pub. No.: US 2015/0193080 A1
(43) Pub. Date: Jul. 9, 2015

(54) TOUCH PAD WITH ANTENNA

(71) Applicant: ALPS ELECTRIC CO., LTD., Tokyo (JP)

(72) Inventors: Hiroaki Takahashi, Miyagi-ken (JP); Takahiro Murakami, Miyagi-ken (JP); Takeshi Masaki, Miyagi-ken (JP)

(21) Appl. No.: 14/579,476

(22) Filed: Dec. 22, 2014

(30) Foreign Application Priority Data
Jan. 7, 2014 (JP) 2014-001163

(51) Int. Cl. G06F 3/041; H01Q 1/48; H01Q 1/22; G06F 3/044; H01Q 7/00

(52) U.S. Cl. CPC G06F 3/0418; G06F 3/044; H01Q 7/00; H01Q 1/22; H01Q 1/48

(57) ABSTRACT

A touch pad with an antenna includes a substrate on an upper side of which an operation surface having a predetermined operation region is set, an electrode group for detecting capacitance configured to be arranged in a region of the substrate corresponding to the operation region, and an antenna for wireless communication configured to be arranged in a region located on a lower side of the substrate, the region overlapping with an electrode forming region in which the electrode group for detecting capacitance is formed, as viewed from above. The electrode group for detecting capacitance includes a first electrode group extended in a predetermined first direction and a second electrode group extended in a second direction perpendicular to the first direction, and the antenna is extended in a direction intersecting with the first direction and the second direction.

### CLAIM OF PRIORITY

This application claims benefit of Japanese Patent Application No. 2014-001163 filed on Jan. 7, 2014, which is hereby incorporated by reference in its entirety.

### BACKGROUND

1. Field of the Disclosure

The present disclosure relates to a touch pad with an antenna, and in particular, relates to a touch pad with an antenna, used for wireless communication.

2. Description of the Related Art

Touch pads in each of which the position of an operation body in contact with or close to an operation surface is detectable have become very popular, and have been used for moving cursors of screens of electronic devices such as notebook computers. The touch pads are each attached to an opening portion formed in a predetermined location (a palm rest or the like) of a chassis covering the main body of an electronic device such as a notebook computer.

The opening portion to which the touch pad is attached is used for radiating, to the outside of the electronic device, a wireless signal (electromagnetic wave signal) generated by a communication circuit on an electronic device side. In addition, in recent years, touch pads with antennas, in each of which an antenna for wireless communication connected to such a communication circuit is integrated with a touch pad, have been put into practical use.

As a touch pad with an antenna of the related art, a touch pad module (touch pad with an antenna) according to Japanese Unexamined Patent Application Publication (Translation of PCT Application) No. 2002-539517 has been proposed. FIGS. 11A and 11B are explanatory diagrams illustrating the configuration of a touch pad module 200 according to Japanese Unexamined Patent Application Publication (Translation of PCT Application) No. 2002-539517. FIG. 11A is an explanatory diagram schematically illustrating the side cross-section of the touch pad module 200. FIG. 11B is an explanatory diagram schematically illustrating the lower surface of a printed circuit board 220 used in the touch pad module 200.

The touch pad module 200 is a capacitive (electrostatic capacitance type) touch pad. As illustrated in FIGS. 11A and 11B, the touch pad module 200 includes the printed circuit board 220 having a nearly rectangular-shaped plate surface, and a touch sensor array 222 including a plurality of layers formed in the upper portion of the printed circuit board 220.

In a portion situated nearer to the center of a lower surface 224 serving as one plate surface of the printed circuit board 220, a chip 226, a chip 228, a configuration element 230, a configuration element 232, a configuration element 234, and so forth are mounted, and configure a circuit unit having a predetermined function. The circuit unit is connected to the touch sensor array 222 through wiring lines not illustrated. In addition, in the outer periphery portion of the lower surface 224 of the printed circuit board 220, an antenna 236 for wireless communication is formed. The antenna 236 is extended along the outer circumference of the lower surface 224 of the printed circuit board 220.

Note that while the detailed structure of the touch sensor array 222 is not disclosed in Japanese Unexamined Patent Application Publication (Translation of PCT Application) No. 2002-539517, usually the touch sensor array of the capacitive touch pad includes a first electrode group extended in the long-side direction of a board having a nearly rectangular-shaped plate surface, and a second electrode group extended in the short-side direction thereof. In addition, based on a change in electrostatic capacitance detected using the first electrode group and the second electrode group, the position of an operation body in contact with or close to the operation surface of the touch pad is detected.

In the touch pad module 200 according to Japanese Unexamined Patent Application Publication (Translation of PCT Application) No. 2002-539517, the antenna 236 is extended along the outer circumference of the nearly rectangular-shaped plate surface of the printed circuit board 220. In addition, as described above, usually the touch sensor array of the capacitive touch pad includes the first electrode group extended in the long-side direction of the board having the nearly rectangular-shaped plate surface, and the second electrode group extended in the short-side direction thereof. Therefore, a large portion of the antenna 236 in the extension direction thereof is headed in a direction parallel to the extension direction of the first electrode group or the second electrode group.

In a point at which the extension direction of the antenna 236 is parallel to the extension direction of the first electrode group or the second electrode group, magnetic field coupling caused by mutual induction is easily produced between the antenna 236 and the first electrode group or the second electrode group. In addition, by magnetic field coupling between the antenna 236 and the first electrode group or the second electrode group, a magnetic field generated by the antenna 236 is easily transmitted, as a noise, to the first electrode group or the second electrode group. As a result, in such a structure as the touch pad module 200 according to Japanese Unexamined Patent Application Publication (Translation of PCT Application) No. 2002-539517, there has been a possibility that, under the influence of the noise due to the antenna 236, detection accuracy at the time of detecting the position of an operation body in contact with or close to an operation surface is reduced.

The present invention is made in view of such a situation of the related art, and provides a touch pad with an antenna, capable of reducing the influence of a noise due to the antenna.

### SUMMARY

According to a first aspect of the present invention, a touch pad with an antenna includes a substrate on an upper side of having set thereon an operation surface having a predetermined operation region, an electrode group that detects capacitance arranged in a region of the substrate corresponding to the operation region, and an antenna for wireless communication arranged in a region located on a lower side of the substrate, the region overlapping with an electrode group forming region in which the electrode group for detecting capacitance is disposed, as viewed from above, wherein the electrode group for detecting capacitance includes a first electrode group extended in a predetermined first direction and a second electrode group extended in a second direction perpendicular to the first direction, and the antenna is extended in a direction intersecting with the first direction and the second direction.

In the touch pad with an antenna having this configuration, the first electrode group is extended in the first direction, and the antenna is extended in the direction intersecting with (a direction not parallel to) the first direction. Therefore, it is possible to suppress magnetic field coupling due to mutual induction between the antenna and the first electrode group. In addition, it is possible to inhibit a magnetic field generated by the antenna from being transmitted, as a noise, to the first electrode group. In addition, the second electrode group is extended in the second direction, and the antenna is extended in the direction intersecting with (a direction not parallel to) the second direction. Therefore, it is possible to suppress magnetic field coupling due to mutual induction between the antenna and the second electrode group. In addition, it is possible to inhibit the magnetic field generated by the antenna from being transmitted, as a noise, to the second electrode group. As a result, the touch pad with an antenna having this configuration is able to reduce the influence of a noise due to the antenna.

### BRIEF DESCRIPTION OF THE DRAWINGS

FIGS. 1A and 1B are explanatory diagrams illustrating a configuration of a touch pad according to a first embodiment of the present invention;

FIG. 2 is an explanatory diagram illustrating a usage example of the touch pad illustrated in FIGS. 1A and 1B;

FIG. 3 is an exploded perspective view of the touch pad illustrated in FIGS. 1A and 1B;

FIGS. 4A and 4B are first explanatory diagrams illustrating electrode geometries of a substrate illustrated in FIGS. 1A and 1B;

FIGS. 5A and 5B are second explanatory diagrams illustrating electrode geometries of the substrate illustrated in FIGS. 1A and 1B;

FIGS. 6A and 6B are explanatory diagrams illustrating a function of an antenna illustrated in FIG. 3;

FIG. 7 is an explanatory diagram illustrating a function of a ground electrode illustrated in FIG. 3;

FIGS. 8A and 8B are explanatory diagrams illustrating a configuration of a touch pad according to a second embodiment of the present invention;

FIGS. 9A and 9B are first explanatory diagrams illustrating electrode geometries of a substrate illustrated in FIGS. 8A and 8B;

FIGS. 10A and 10B are second explanatory diagrams illustrating electrode geometries of the substrate illustrated in FIGS. 8A and 8B; and

FIGS. 11A and 11B are explanatory diagrams illustrating a configuration of a touch pad module according to Japanese Unexamined Patent Application Publication (Translation of PCT Application) No. 2002-539517.

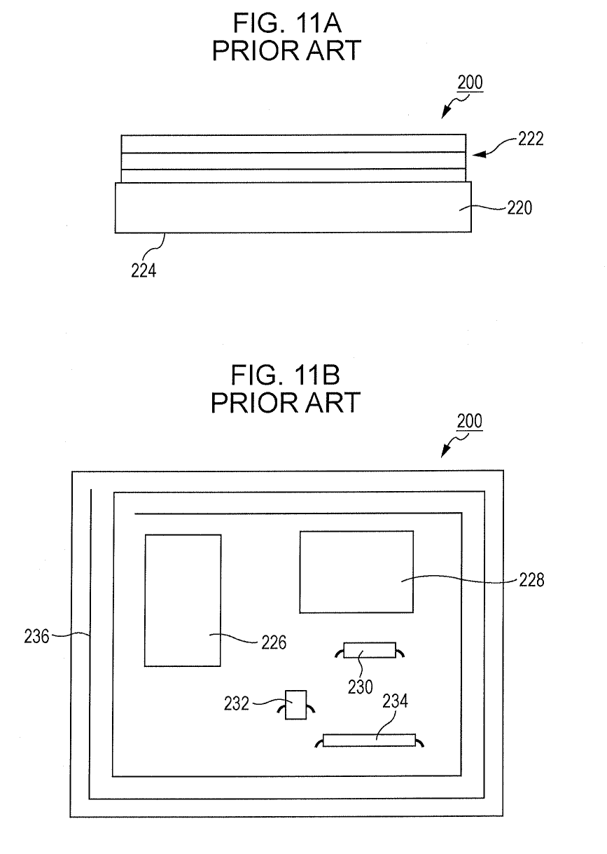

### DESCRIPTION OF THE EXEMPLARY EMBODIMENTS

### First Embodiment

Hereinafter, a first embodiment of the present invention will be described with reference to drawings. Note that it is assumed that, in each drawing, an X1 direction is a left direction, an X2 direction is a right direction, a Y1 direction is an anterior direction, a Y2 direction is a posterior direction, a Z1 direction is an upper direction, and a Z2 direction is a lower direction and an explanation will be made.

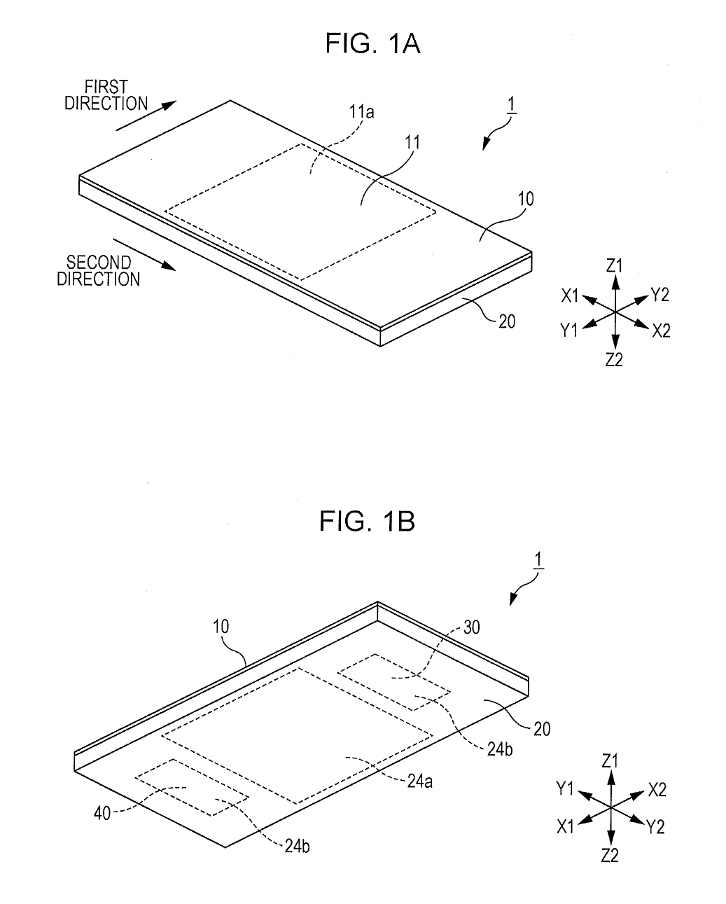

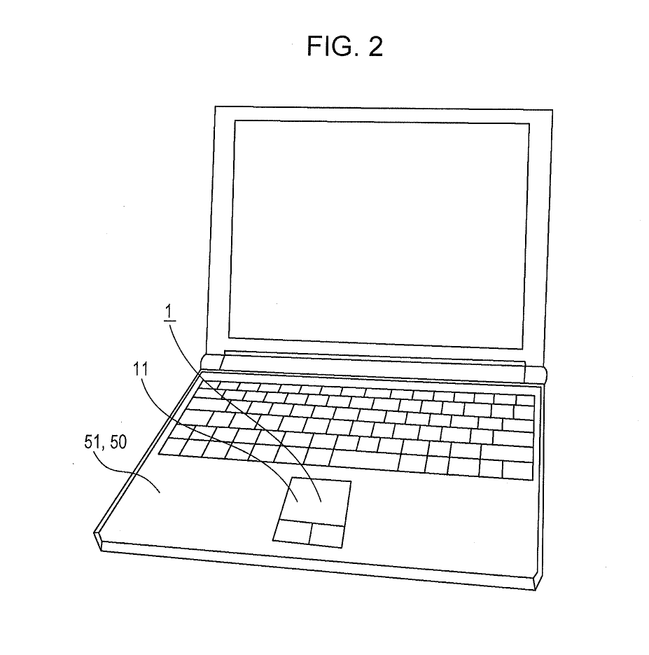

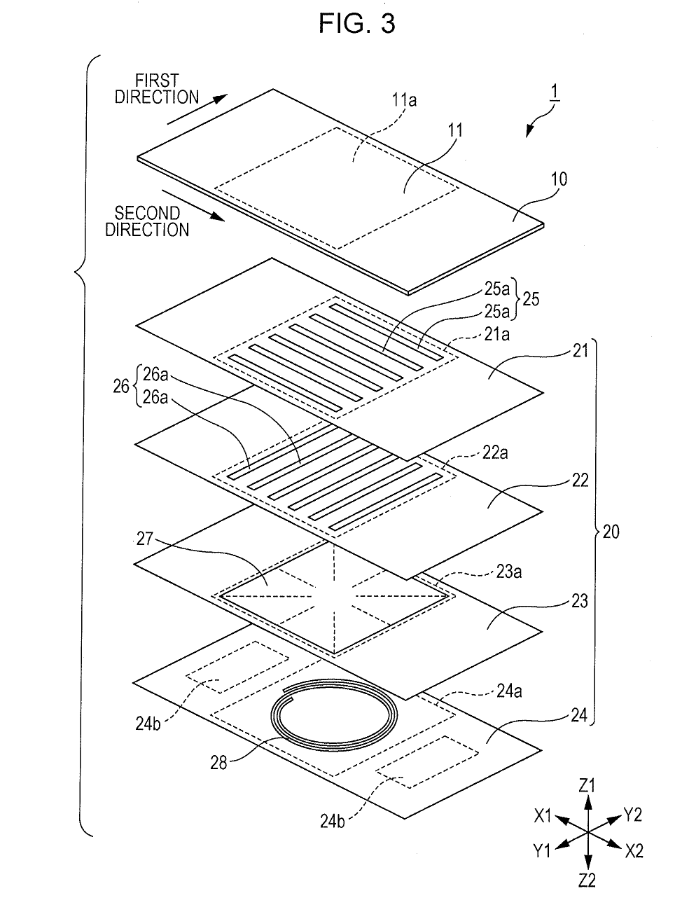

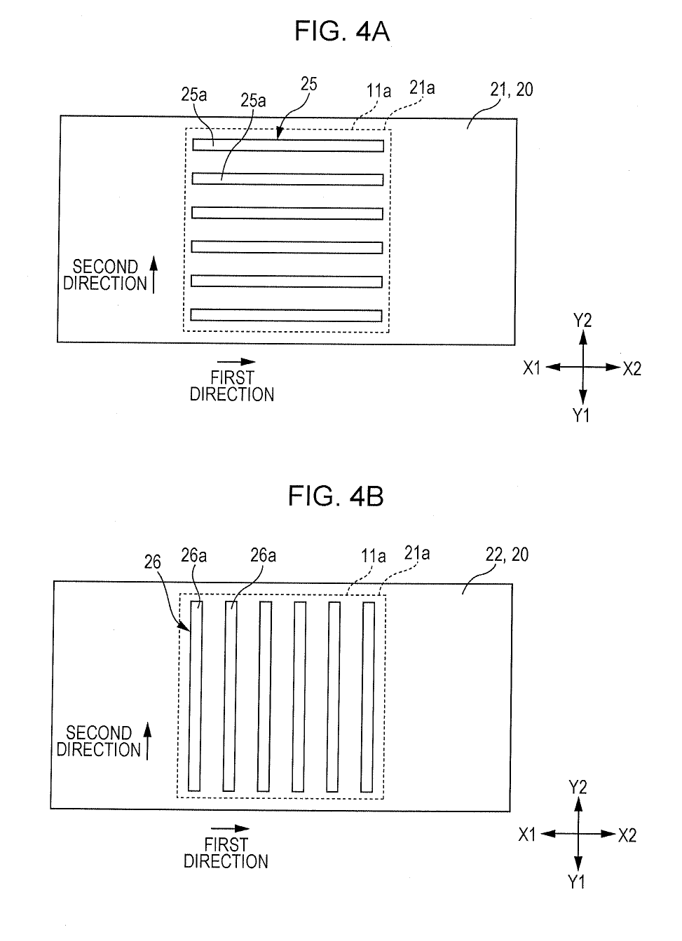

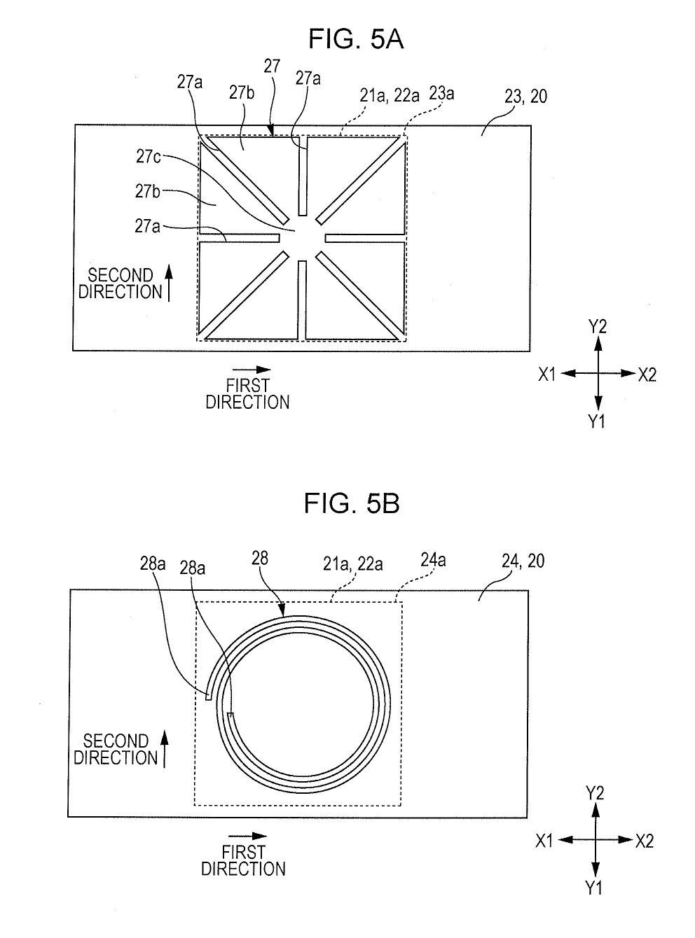

First, the configuration of a touch pad 1 (a touch pad with an antenna) according to the first embodiment of the present invention will be described using FIG. 1A to FIG. 5B. FIGS. 1A and 1B are explanatory diagrams illustrating the configuration of the touch pad 1 according to the first embodiment of the present invention. FIG. 2 is an explanatory diagram illustrating a usage example of the touch pad 1 illustrated in FIGS. 1A and 1B. FIG. 3 is the exploded perspective view of the touch pad 1 illustrated in FIGS. 1A and 1B. FIGS. 4A and 4B are first explanatory diagrams illustrating the electrode geometries of a substrate 20 illustrated in FIGS. 1A and 1B. FIG. 4A is an explanatory diagram illustrating the electrode geometry of a first electrode group 25, and FIG. 4B is an explanatory diagram illustrating the electrode geometry of a second electrode group 26. FIGS. 5A and 5B are second explanatory diagrams illustrating the electrode geometries of the substrate 20 illustrated in FIGS. 1A and 1B. FIG. 5A is an explanatory diagram illustrating the electrode geometry of a ground electrode 27, and FIG. 5B is an explanatory diagram illustrating the electrode geometry of an antenna 28.

The touch pad 1 is a touch pad of a type called an electrostatic capacitance type. As illustrated in FIGS. 1A and 1B, the touch pad 1 includes an operation plate 10 with an operation surface 11 on the upper side thereof, and the substrate 20 arranged on the lower side of the operation plate 10. In addition, the touch pad 1 is able to detect the position of an operation body such as a fingertip in contact with or close to the operation surface 11. As illustrated in FIG. 2, such a touch pad 1 is attached to a predetermined location (a palm rest or the like) of a chassis 51 of an electronic device 50 such as a notebook computer so that the operation surface 11 is exposed, and the touch pad 1 is used for moving a cursor of a screen, or the like.

The operation plate 10 is a plate-like member made of a synthetic resin, and includes nearly rectangular-shaped plate surfaces on the top and bottom thereof. As illustrated in FIG. 3, the top surface of the operation plate 10 is the operation surface 11, and a predetermined region of the operation surface 11 is an operation region 11a. In the present embodiment, the operation region 1 1a is a square-shaped region having sides extending in a first direction on the operation surface 11 and a second direction perpendicular to the first direction. As illustrated in FIG. 3, the first direction is a horizontal direction, and the second direction is a front-back direction.

The substrate 20 is a multilayer substrate made of a synthetic resin, and includes nearly rectangular-shaped plate surfaces on the top and bottom thereof. As illustrated in FIG. 3, the substrate 20 includes four electrode forming layers of a first electrode forming layer 21, a second electrode forming layer 22, a ground electrode forming layer 23, and an antenna forming layer 24. Predetermined electrodes made of a conductive material such as copper are formed in the first electrode forming layer 21, the second electrode forming layer 22, the ground electrode forming layer 23, and the antenna forming layer 24.

The first electrode forming layer 21, the second electrode forming layer 22, the ground electrode forming layer 23, and the antenna forming layer 24 are stacked with sandwiching therebetween insulation layers not illustrated, in the order of the first electrode forming layer 21, the second electrode forming layer 22, the ground electrode forming layer 23, and the antenna forming layer 24 starting from the top. In addition, the first electrode forming layer 21 is the top surface of the substrate 20, and the antenna forming layer 24 is the bottom surface of the substrate 20. The upper side of the first electrode forming layer 21 and the lower side of the antenna forming layer 24 are covered by insulating coatings not illustrated.

In the first electrode forming layer 21 of the substrate 20, the first electrode group 25 serving as a first electrode group for detecting capacitance is formed. The first electrode group 25 is formed in the inside of a first electrode forming region 21a serving as a square-shaped region overlapping with the operation region 11a as viewed from above. The first electrode group 25 includes a plurality of first electrodes 25a. As illustrated in FIGS. 4A and 4B, each of the first electrodes 25a is a nearly rectangular-shaped electrode extended in the first direction. The first electrodes 25a may be arranged so as to be placed at regular intervals in the second direction. Note that, in the present embodiment, the first electrodes 25a of the first electrode group 25 are used as drive electrodes, and an electric signal for driving is applied to each of the first electrodes 25a.

In the second electrode forming layer 22 of the substrate 20, the second electrode group 26 serving as a second electrode group for detecting capacitance is formed. The second electrode group 26 is formed in the inside of a second electrode forming region 22a serving as a square-shaped region overlapping with the operation region 11a as viewed from above. The second electrode group 26 includes a plurality of second electrodes 26a. As illustrated in FIGS. 4A and 4B, each of the second electrodes 26a is a nearly rectangular-shaped electrode extended in the second direction. The second electrodes 26a may be arranged so as to be placed at regular intervals in the first direction. Note that, in the present embodiment, the second electrodes 26a of the second electrode group 26 are used as detection electrodes.

The first electrodes 25a of the first electrode group 25 and the second electrodes 26a of the second electrode group 26 are arranged so as to intersect with each other as viewed from above. In addition, one of the first electrodes 25a and a corresponding one of the second electrodes 26a form electrostatic capacitance in the vicinity of a position at which one of the first electrodes 25a and the corresponding one of the second electrodes 26a intersect with each other. In addition, by the electrostatic capacitance between one of the first electrodes 25a and the corresponding one of the second electrodes 26a, the electric signal for driving applied to one of the first electrodes 25a is transmitted from one of the first electrodes 25a to the corresponding one of the corresponding second electrodes 26a. In the touch pad 1, based on a change in the electric signal transmitted from one of the first electrodes 25a to the corresponding one of the corresponding second electrodes 26a in this way, it is possible to detect a change in the electrostatic capacitance between one of the first electrodes 25a and the corresponding one of the second electrodes 26a.

The ground electrode 27 is formed in the ground electrode forming layer 23 of the substrate 20. The ground electrode 27 may be formed in the inside of a ground electrode forming region 23a serving as a square-shaped region overlapping with the whole regions of the first electrode forming region 21a and the second electrode forming region 22a as viewed from above.

As illustrated in FIGS. 5A and 5B, the ground electrode 27 may be formed by adding a plurality of slits 27a to a square-shaped electrode covering the whole region of the ground electrode forming region 23a. The slits 27a may be arranged at regular intervals in a rotation direction centered at the central portion of the ground electrode 27. In addition, the slits 27a may each radially extend from the vicinity of the central portion of the ground electrode 27 to the outer periphery portion thereof. The outer periphery portion of the ground electrode 27 may be divided into a plurality of ground electrode patterns 27b by the slits 27a. The central portion of the ground electrode 27 may be a linking portion 27c linking the ground electrode patterns 27b divided by the slits 27a.

In the antenna forming layer 24 of the substrate 20, an electrode pattern to serve as the antenna 28 for wireless communication is formed. Hereinafter, the electrode pattern to serve as the antenna 28 for wireless communication is abbreviated as the antenna 28. The antenna 28 is formed in the inside of an antenna forming region 24a serving as a square-shaped region overlapping with the first electrode forming region 21a and the second electrode forming region 22a as viewed from above.

As illustrated in FIGS. 5A and 5B, the antenna 28 may be a coiled (spiral-coil-shaped) antenna wound along the outer circumference of a circle sharing the center thereof with the antenna forming region 24a. Two end portions of the antenna 28 are terminal portions 28a connected to a circuit.

A region on the left side of the antenna forming region 24a and a region on the right side thereof in the antenna forming layer 24 are circuit forming regions 24b in which predetermined circuits are formed. In the circuit forming regions 24b, various kinds of electronic components not illustrated are mounted and a detection circuit 30 for detecting the position of the operation body in contact with or close to the operation surface 11, a communication circuit 40 for wireless communication, and so forth are formed.

The detection circuit 30 is connected to the first electrode group 25 and the second electrode group 26, described above, through electrodes for wiring lines, not illustrated. The detection circuit 30 applies an electric signal for driving to each of the first electrodes 25a of the first electrode group 25, detects an electric signal transmitted to a corresponding one of the second electrodes 26a of the second electrode groups 26, and detects, based on a change in an electric signal transmitted from one of the first electrodes 25a to a corresponding one of the second electrodes 26a, a change in electrostatic capacitance between one of the first electrodes 25a and the corresponding one of the second electrodes 26a. In addition, based on a change in the electrostatic capacitance detected using the first electrode group 25 and the second electrode group 26, the detection circuit 30 detects the position of the operation body in contact with or close to the operation surface 11 of the touch pad 1. Note that since the circuit configuration and so forth of such a detection circuit 30 are publicly known, the detailed descriptions thereof will be omitted.

The communication circuit 40 is a communication circuit compatible with the standard of short distance wireless communication. The communication circuit 40 is connected to the terminal portions 28a of the antenna 28 through electrodes for wiring lines not illustrated. In addition, the communication circuit 40 applies an electric signal for wireless communication to the terminal portions 28a of the antenna 28. Note that since the circuit configuration of such a communication circuit 40 is publicly known, the detailed description thereof will be omitted.

The substrate 20 has such a configuration as described above. In addition, the operation plate 10 is stuck on the upper side of such a substrate 20 using an adhesive or the like. As a result, the operation surface 11 having the predetermined operation region 11a is set on the upper side of the substrate 20.

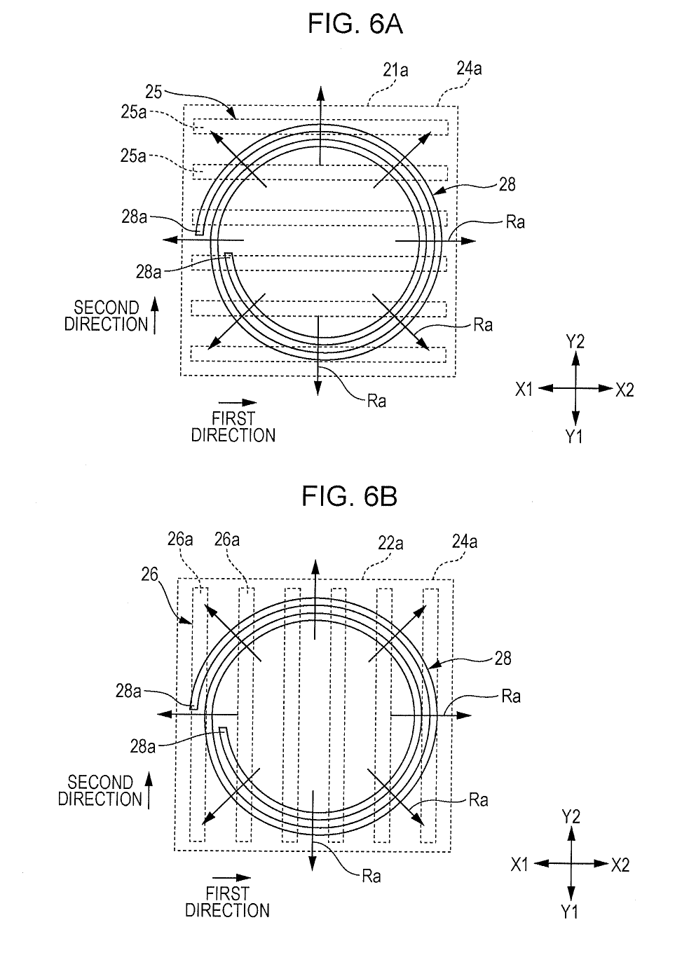

Next, the function of the antenna 28 will be described using FIGS. 6A and 6B. FIGS. 6A and 6B are explanatory diagrams illustrating the function of the antenna 28 illustrated in FIG. 3. FIG. 6A is an explanatory diagram schematically illustrating the radiation direction Ra of a magnetic flux generated by the antenna 28 in a case of viewing the antenna 28 from above along with the first electrode group 25. FIG. 6B is an explanatory diagram schematically illustrating the radiation direction Ra of the magnetic flux generated by the antenna 28 in a case of viewing the antenna 28 from above along with the second electrode group 26.

When the electric signal for wireless communication is applied to the terminal portions 28a of the antenna 28, a current corresponding to the applied electric signal flows through the antenna 28, and a magnetic flux is generated in a direction perpendicular to the current flowing through the antenna 28. In addition, in response to the magnetic flux generated by the antenna 28, a magnetic field is formed around the antenna 28. In FIGS. 6A and 6B, the magnetic flux generated by the antenna 28 is radiated in a direction from the center of the antenna forming region 24a toward the outer side portion thereof. In addition, a magnetic field distribution approximately rotationally symmetrical to the center of the antenna forming region 24a is formed. Using the magnetic field formed in this way, the antenna 28 performs transmission and reception of signals to and from an external communication device not illustrated.

Note that, as will be appreciated from the above-mentioned configuration of the touch pad 1, the first electrode group 25 is arranged on the upper side of the antenna 28. The first electrodes 25a of the first electrode group 25 are extended in the first direction, as illustrated in FIG. 6A. In a case where the antenna 28 is extended in, for example, the first direction (a direction parallel to the extension direction of the first electrodes 25a) with respect to such first electrodes 25a, magnetic field coupling due to mutual induction is easily produced between the antenna 28 and a corresponding one of the first electrodes 25a at a point at which the extension direction of the antenna 28 and the extension direction of the corresponding one of the first electrodes 25a are parallel to each other. The strength of the magnetic field coupling between the antenna 28 and the corresponding one of the first electrodes 25a increases with an increase in the length of the point at which the extension direction of the antenna 28 and the extension direction of the corresponding one of the first electrodes 25a are parallel to each other.

In addition, by the magnetic field coupling between the antenna 28 and the corresponding one of the first electrodes 25a, a magnetic field generated by the antenna 28 is caused to be easily transmitted to the corresponding one of the first electrodes 25a, as a noise. As a result, there is a possibility that, under the influence of the noise due to the antenna 28, detection accuracy at the time of detecting the position of the operation body in contact with or close to the operation surface is reduced.

However, the antenna 28 may be a coiled antenna wound along the outer circumference of a circle sharing the center thereof with the antenna forming region 24a, and there is hardly a point at which the extension direction of the antenna 28 and the extension direction of a corresponding one of the first electrodes 25a are parallel to each other. Therefore, it is possible to suppress magnetic field coupling due to mutual induction between the antenna 28 and the first electrodes 25a. In addition, it is possible to inhibit the magnetic field generated by the antenna 28 from being transmitted to the first electrodes 25a, as a noise.

In addition, as will be appreciated from the above-mentioned configuration of the touch pad 1, the second electrode group 26 is arranged on the upper side of the antenna 28. The second electrodes 26a of the second electrode group 26 are extended in the second direction, as illustrated in FIG. 6B. In a case where the antenna 28 is extended in, for example, the second direction (a direction parallel to the extension direction of the second electrodes 26a) with respect to such second electrodes 26a, magnetic field coupling due to mutual induction is easily produced between the antenna 28 and a corresponding one of the second electrodes 26a at a point at which the extension direction of the antenna 28 and the extension direction of the corresponding one of the second electrodes 26a are parallel to each other. In addition, by the magnetic field coupling between the antenna 28 and the corresponding one of the second electrodes 26a, a magnetic field generated by the antenna 28 is caused to be easily transmitted to the corresponding one of the second electrodes 26a, as a noise.

However, the antenna 28 may be a coiled antenna wound along the outer circumference of a circle sharing the center thereof with the antenna forming region 24a, and there is hardly a point at which the extension direction of the antenna 28 and the extension direction of a corresponding one of the second electrodes 26a are parallel to each other. Therefore, it is possible to suppress magnetic field coupling due to mutual induction between the antenna 28 and the second electrodes 26a. In addition, it is possible to inhibit the magnetic field generated by the antenna 28 from being transmitted to the second electrodes 26a, as a noise.

Note that the antenna 28 may be a coiled antenna wound along the outer circumference of a circle. Therefore, strictly speaking, in the vicinity of the anterior end portion of the antenna 28 and in the vicinity of the posterior end portion thereof, there are points at which the extension direction of the antenna 28 and the extension direction of the first electrodes 25a are parallel to each other. However, since such points each have no sufficient length, it is possible to regard the antenna 28 as a coil extended in a direction intersecting with the extension direction of the first electrodes 25a.

In addition, in the same way, in the vicinity of the left end portion of the antenna 28 and in the vicinity of the right end portion thereof, there are points at which the extension direction of the antenna 28 and the extension direction of the second electrodes 26a are parallel to each other. However, since such points each have no sufficient length, it is possible to regard the antenna 28 as a coil extended in a direction intersecting with the extension direction of the second electrodes 26a.

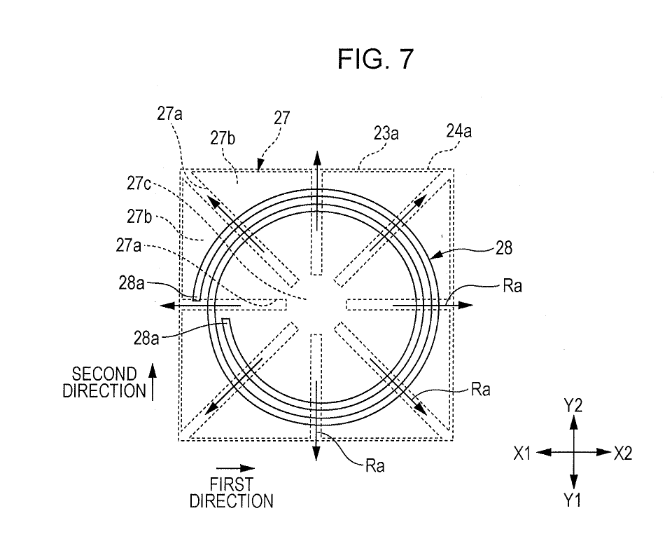

Next, using FIG. 7, the function of the ground electrode 27 will be described. FIG. 7 is an explanatory diagram illustrating the function of the ground electrode 27 illustrated in FIG. 3. FIG. 7 is an explanatory diagram schematically illustrating the radiation direction Ra of the magnetic flux generated by the antenna 28 in a case of viewing the antenna 28 from above along with the ground electrode 27.

As will be appreciated from the above-mentioned configuration of the touch pad 1, the ground electrode 27 may be arranged at a position, located on the lower side of the first electrode group 25 and the second electrode group 26 and located on the upper side of the antenna 28. In addition, the ground electrode 27 inhibits an electromagnetic wave noise generated by the main body of the electronic device 50 from being radiated to the outside of the electronic device 50, and inhibits the magnetic field generated by the antenna 28 from being transmitted, as a noise, to the first electrode group 25 and the second electrode group 26.

In addition, as illustrated in FIG. 7, the slits 27a may be formed in the ground electrode 27. In addition, a signal for wireless communication is radiated from the antenna 28 to the outside of the electronic device 50 through the slits 27a. Furthermore, the slits 27a may be arranged at regular intervals in the rotation direction centered at the center of the ground electrode 27. In addition, the bias of the signal with respect to the rotation direction centered at the center of the ground electrode 27 is reduced, the signal being radiated from the antenna 28 to the outside of the electronic device 50 through the slits 27a.

In addition, the slits 27a have a function for suppressing an eddy current flowing through the ground electrode 27. In general, in a case where the ground electrode 27 is arranged on the upper side of such a coiled antenna as the antenna 28, an eddy current flows through the ground electrode 27 in the extension direction of the antenna 28 in response to the magnetic field generated by the antenna 28. In addition, in connection with the eddy current flowing through the ground electrode 27, the loss of electric power is generated. In contrast, as illustrated in FIG. 7, in the present embodiment, the slits 27a may be formed so as to radially extend from the vicinity of the central portion of the ground electrode 27, and such slits 27a suppress the eddy current flowing through the ground electrode 27 in response to the magnetic field generated by the antenna 28.

Note that the slits 27a may divide the outer periphery portion of the ground electrode 27 into the ground electrode patterns 27b. Usually, the antenna 28 is formed in the vicinity of the outer periphery portion of the antenna forming region 24a. Therefore, the strength of the magnetic field generated by the antenna 28 increases in the vicinity of the outer periphery portion of the antenna forming region 24a, compared with the vicinity of the central portion of the antenna forming region 24a. In response to that, the magnitude of an eddy current flowing through the vicinity of the outer periphery portion of the ground electrode 27 becomes larger than that of an eddy current flowing through the vicinity of the central portion thereof. In addition, compared with the path of the eddy current flowing through the vicinity of the central portion of the ground electrode 27, the path of the eddy current flowing through the vicinity of the outer periphery portion of the ground electrode 27 is long. Therefore, compared with a loss due to the eddy current flowing through the vicinity of the central portion of the ground electrode 27, a loss due to the eddy current flowing through the vicinity of the outer periphery portion thereof becomes large. Therefore, in a case of forming the slits 27a, a case of forming the slits 27a so as to divide the outer periphery portion of the ground electrode 27 obtains a great advantageous effect compared with a case of forming the slits 27a so as to divide the central portion of the ground electrode 27.

Next, advantageous effects of the present embodiment will be described. In the touch pad 1 of the present embodiment, the first electrodes 25a of the first electrode group 25 are extended in the first direction (horizontal direction), and the antenna 28 is extended in a direction intersecting with (a direction not parallel to) the first direction. Therefore, it is possible to suppress magnetic field coupling due to mutual induction between the antenna 28 and the first electrodes 25a of the first electrode group 25. In addition, it is possible to inhibit the magnetic field generated by the antenna 28 from being transmitted, as a noise, to the first electrodes 25a of the first electrode group 25. In addition, the second electrodes 26a of the second electrode group 26 are extended in the second direction (front-back direction), and the antenna 28 is extended in a direction intersecting with (a direction not parallel to) the second direction. Therefore, it is possible to suppress magnetic field coupling due to mutual induction between the antenna 28 and the second electrodes 26a of the second electrode group 26. In addition, it is possible to inhibit the magnetic field generated by the antenna 28 from being transmitted, as a noise, to the second electrodes 26a of the second electrode group 26. As a result, the touch pad 1 of this configuration is able to reduce the influence of a noise due to the antenna 28.

In addition, in the touch pad 1 of the present embodiment, the antenna 28 may be a coiled antenna wound along the outer circumference of a circle. Therefore, the antenna 28 is able to form a magnetic field approximately rotationally symmetrical to the center of the circle. As a result, it is possible to reduce the bias of a communication sensitivity with respect to a communication direction. In particular, the shape of such an antenna 28 is effective for a touch pad having a square-shaped operation region.

In addition, in the touch pad 1 of the present embodiment, using the ground electrode 27 arranged at a position, located on the lower side of the first electrode group 25 and the second electrode group 26 and located on the upper side of the antenna 28, it is possible to inhibit the electromagnetic wave noise generated by the main body of the electronic device 50 from being radiated to the outside of the electronic device 50, and it is possible to further inhibit the magnetic field generated by the antenna 28 from being transmitted, as a noise, to the first electrode group 25 and the second electrode group 26. Furthermore, since the slits 27a may be formed in the ground electrode 27, it is possible to radiate the signal for wireless communication from the antenna 28 to the outside of the electronic device 50 through the slits 27a. In addition, since the slits 27a may radially extend from the vicinity of the central portion of the ground electrode 27, it is possible to suppress the eddy current flowing through the ground electrode 27 in response to the magnetic field generated by the antenna 28. In addition, it is possible to reduce a loss associated with the eddy current.

In addition, in the touch pad 1 of the present embodiment, the slits 27a may be arranged at regular intervals in the rotation direction centered at the center of the ground electrode 27. Therefore, it is possible to reduce the bias of a signal with respect to the rotation direction centered at the center of the ground electrode 27, the signal being radiated from the antenna 28 to the outside of the electronic device 50 through the slits 27a.

In addition, in the touch pad 1 of the present embodiment, the slits 27a may be formed so as to divide the outer periphery portion of the ground electrode 27. Therefore, it is possible to prevent the eddy current from flowing through the vicinity of the outer periphery portion of the ground electrode 27. As a result, it is possible to further suppress the eddy current flowing through the ground electrode 27 in response to the magnetic field generated by the antenna 28. In addition, it is possible to further reduce a loss associated with the eddy current.

In addition, while, in the touch pad 1 of the present embodiment, the outer periphery portion of the ground electrode 27 may be divided by the slits 27a into the ground electrode patterns 27b, it is possible to electrically connect the ground electrode patterns 27b using the linking portion 27c. Therefore, it is possible to reduce the number of ground wiring lines connected to the ground electrode 27, compared with a case where the ground electrode patterns 27b are not linked to the linking portion 27c. As a result, it is possible to simplify the structure of the touch pad 1.

### Second Embodiment

Hereinafter, a second embodiment of the present invention will be described with reference to drawings. Note that, in the present embodiment, in a case of the same configuration as that of the above-mentioned first embodiment, a same symbol is assigned thereto and the detailed description thereof will be omitted.

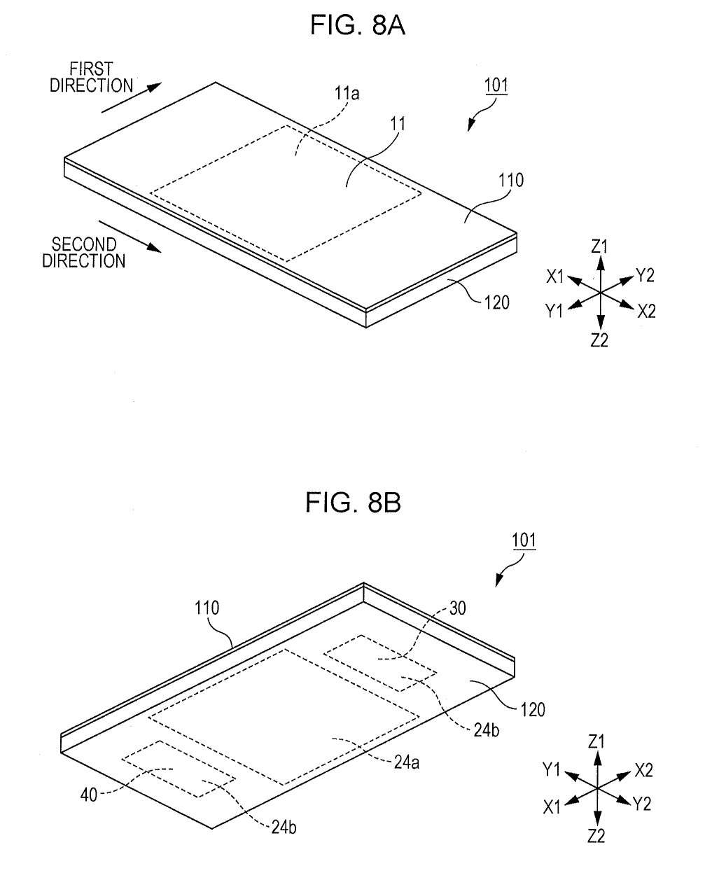

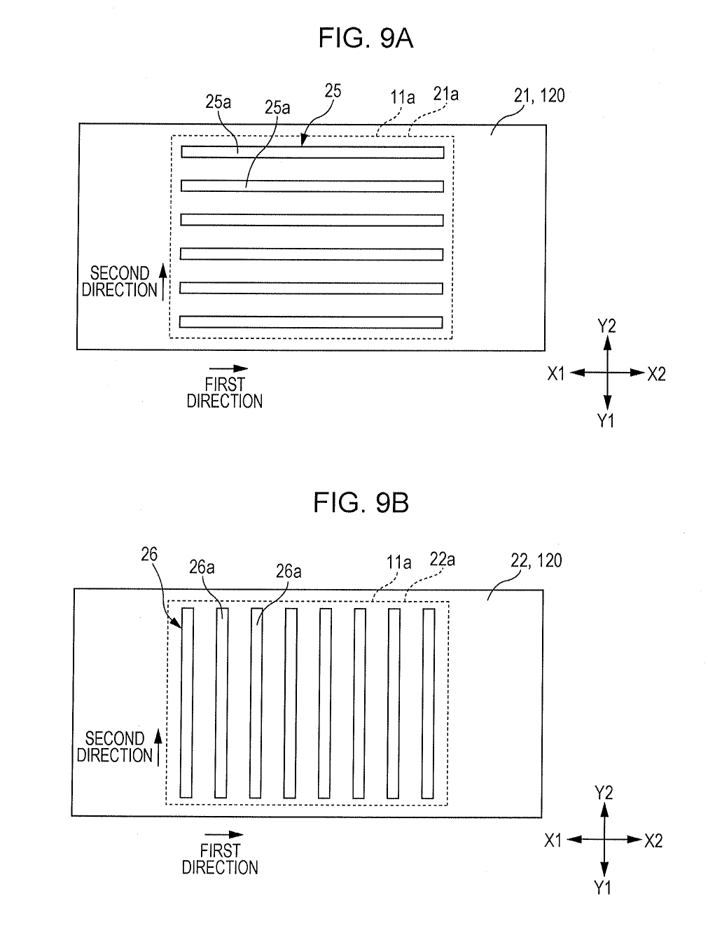

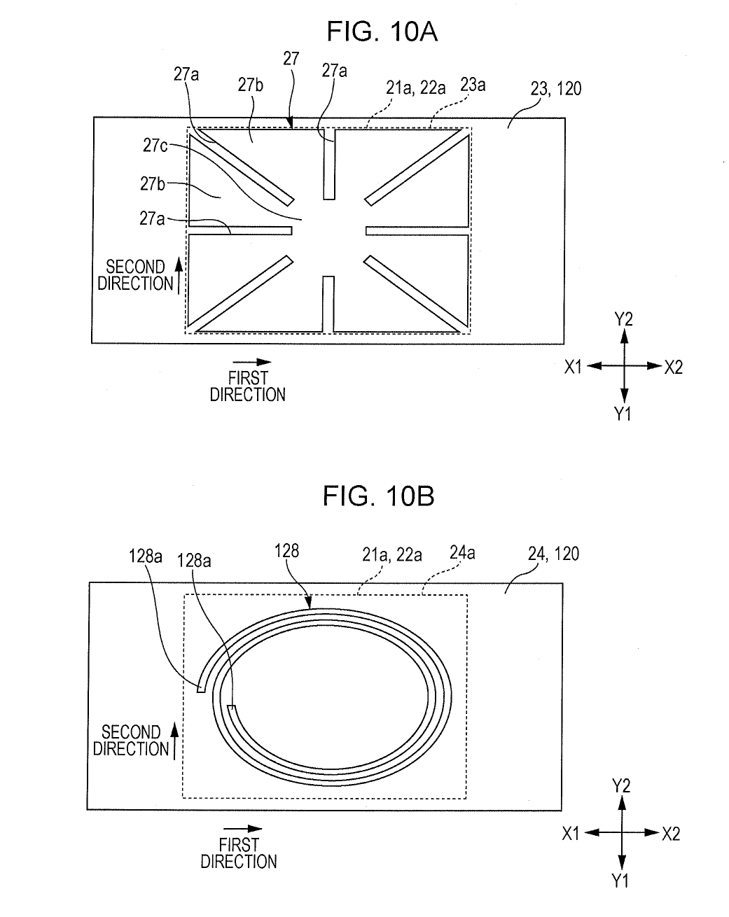

First, the configuration of a touch pad 101 (a touch pad with an antenna) according to the second embodiment of the present invention will be described using FIG. 8A to FIG. 10B. FIGS. 8A and 8B are explanatory diagrams illustrating the configuration of the touch pad 101 according to the second embodiment of the present invention. FIGS. 9A and 9B are first explanatory diagrams illustrating the electrode geometries of a substrate 120 illustrated in FIGS. 8A and 8B. FIG. 9A is an explanatory diagram illustrating the electrode geometry of the first electrode group 25, and FIG. 9B is an explanatory diagram illustrating the electrode geometry of the second electrode group 26. FIGS. 10A and 10B are second explanatory diagrams illustrating the electrode geometries of the substrate 120 illustrated in FIGS. 8A and 8B. FIG. 10A is an explanatory diagram illustrating the electrode geometry of the ground electrode 27, and FIG. 10B is an explanatory diagram illustrating the electrode geometry of an antenna 128.

In the same way as the touch pad 1 of the first embodiment, the touch pad 101 is a touch pad of a type called an electrostatic capacitance type. As illustrated in FIGS. 8A and 8B, the touch pad 101 includes an operation plate 110, and the substrate 120 arranged on the lower side of the operation plate 110. In addition, the top surface of the operation plate 110 is the operation surface 11, and a predetermined region of the operation surface 11 is the operation region 11a. In this regard, however, in the present embodiment, the operation region 11a may be a rectangular-shaped region having long sides extending in the first direction on the operation surface 11 and short sides extending in the second direction perpendicular to the first direction. While not illustrated, the substrate 120 includes four electrode forming layers of the first electrode forming layer 21, the second electrode forming layer 22, the ground electrode forming layer 23, and the antenna forming layer 24, in the same way as the substrate 20 of the first embodiment.

In the first electrode forming layer 21 of the substrate 120, the first electrode group 25 is formed in the same way as the first embodiment. In this regard, however, as illustrated in FIGS. 9A and 9B, the first electrode forming region 21a of the first electrode forming layer 21 is a rectangular-shaped region overlapping with the operation region 11a as viewed from above. In the second electrode forming layer 22 of the substrate 120, the second electrode group 26 is formed in the same way as the first embodiment. In this regard, however, as illustrated in FIGS. 9A and 9B, the second electrode forming region 22a of the second electrode forming layer 22 is a rectangular-shaped region overlapping with the operation region 11a as viewed from above.

In the ground electrode forming layer 23 of the substrate 120, the ground electrode 27 is formed in the same way as the first embodiment. In this regard, however, as illustrated in FIGS. 10A and 10B, the ground electrode forming region 23a of the ground electrode forming layer 23 is a rectangular-shaped region overlapping the whole regions of the first electrode forming region 21a and the second electrode forming region 22a as viewed from above. In addition, the ground electrode 27 may be formed by adding the slits 27a to a nearly rectangular-shaped electrode covering the whole region of the ground electrode forming region 23a.

In the antenna forming layer 24 of the substrate 120, not the antenna 28 but the antenna 128 is formed as illustrated in FIGS. 10A and 10B. In addition, the antenna forming region 24a of the antenna forming layer 24 is a rectangular-shaped region overlapping with the first electrode forming region 21a and the second electrode forming region 22a as viewed from above. The antenna 128 may be a coiled (spiral-coil-shaped) antenna wound along the outer circumference of an ellipse having a long axis extending in the first direction and a short axis extending in the second direction. The outside dimension of the antenna 128 is set so that distances from the outer periphery portion of the operation region 11a to the antenna 128 in a long-side direction and a short-side direction become approximately equal to each other. Two end portions of the antenna 128 are terminal portions 128a connected to a circuit.

Next, advantageous effects of the present embodiment will be described. In the touch pad 101 of the present embodiment, the first electrodes 25a of the first electrode group 25 are extended in the first direction (horizontal direction), and the antenna 128 is extended in a direction intersecting with (a direction not parallel to) the first direction. Therefore, it is possible to suppress magnetic field coupling due to mutual induction between the antenna 128 and the first electrodes 25a of the first electrode group 25. In addition, it is possible to inhibit a magnetic field generated by the antenna 128 from being transmitted, as a noise, to the first electrodes 25a of the first electrode group 25. In addition, the second electrodes 26a of the second electrode group. 26 are extended in the second direction (front-back direction), and the antenna 128 is extended in a direction intersecting with (a direction not parallel to) the second direction. Therefore, it is possible to suppress magnetic field coupling due to mutual induction between the antenna 128 and the second electrodes 26a of the second electrode group 26. In addition, it is possible to inhibit the magnetic field generated by the antenna 128 from being transmitted, as a noise, to the second electrodes 26a of the second electrode group 26. As a result, the touch pad 101 of this configuration is able to reduce the influence of a noise due to the antenna 128.

In addition, depending on the application or standard of the electronic device 50, there is a case where a touch pad having not a square-shaped operation region but a rectangular-shaped operation region in such a manner as the touch pad 101 is used. In a case where, with respect to such a touch pad, the antenna 128 is, for example, a coiled antenna wound along the outer circumference of a circle, distances from the outer periphery portion of the operation region 11a to the antenna 128 in the long-side direction and the short-side direction are different from each other. As a result, there is a possibility that the bias of the communication sensitivity with respect to the communication direction is produced even if distances from the outer periphery portion of the operation region 11a are equal to each other.

However, in the touch pad 101 of the present embodiment, the operation region 11a may be the rectangular-shaped region having the long sides extending in the first direction (horizontal direction) and the short sides extending in the second direction (front-back direction), and the antenna 128 may be the coiled antenna wound along the outer circumference of the ellipse having the long axis extending in the first direction and the short axis extending in the second direction. Therefore, compared with a case where the antenna 128 is the coiled antenna wound along the outer circumference of a circle, it is possible to reduce the bias of a distance from the outer periphery portion of the operation region 11a to the antenna 128. As a result, even in a case of a touch pad having the rectangular-shaped operation region 11a in such a manner as the touch pad 101, it is possible to reduce the bias of the communication sensitivity with respect to the communication direction.

While embodiments of the present invention are described as above, the present invention is not limited to the above-mentioned embodiments, and may be arbitrarily modified without departing from the scope of purposes of the present invention.

For example, in an embodiment of the present invention, an electronic device to which the touch pad 1 (or the touch pad 101) is to be attached may be a device other than the notebook computer. The touch pad 1 (or the touch pad 101) may be used as an input device such as, for example, a game machine or an in-vehicle navigation device.

In addition, in an embodiment of the present invention, the touch pad 1 (or the touch pad 101) may include a member other than the above-mentioned members. The touch pad 1 (or the touch pad 101) may include, for example, a supporting member for swingably attaching itself to an electronic device. In addition, a push switch or the like for detecting the swinging operation of the touch pad 1 (or the touch pad 101) may be attached to the bottom surface of the substrate 20 (or the substrate 120). In addition, the touch pad 1 (or the touch pad 101) may include an attaching structure for attaching itself to the chassis of the electronic device 50.

In addition, in an embodiment of the present invention, the operation region 11a may have a shape other than the above-mentioned shapes. A corner portion of the square shape (or the rectangular shape) of the operation region 11a may have, for example, a circular arc shape. In addition, if it is possible to detect the position of the operation body in contact with or close to the operation surface 11 with predetermined accuracy, the operation region 11a may be a circular-shaped or elliptical-shaped region.

In addition, in an embodiment of the present invention, the substrate 20 (or the substrate 120) is allowed not to include the circuit forming region 24b, and the touch pad 1 (or the touch pad 101) is allowed not to include the detection circuit 30 or the communication circuit 40. In addition, the first electrode group 25 and the second electrode group 26 may be connected to, for example, a detection circuit and a communication circuit, formed on the main body side of the electronic device 50, through wiring lines or the like.

In addition, in an embodiment of the present invention, the first electrodes 25a of the first electrode group 25 and the second electrodes 26a of the second electrode group 26 may each have a shape other than a rectangular shape. The first electrodes 25a may be electrodes in which, for example, a plurality of rhomboid-shaped electrodes linked to each other are arranged so as to be placed alongside each other in the first direction. In addition, the second electrodes 26a may be electrodes in which a plurality of rhomboid-shaped electrodes linked to each other are arranged so as to be placed alongside each other in the second direction.

In addition, while, in the embodiments of the present invention, the first electrodes 25a of the first electrode group 25 are used as drive electrodes and the second electrodes 26a of the second electrode group 26 are used as detection electrodes, the second electrodes 26a may be used as drive electrodes and the first electrodes 25a may be used as detection electrodes. In addition, a state in which the first electrodes 25a are used as drive electrodes and the second electrodes 26a are used as detection electrodes and a state in which the second electrodes 26a are used as drive electrodes and the first electrodes 25a are used as detection electrodes may be alternately switched depending on the timing of detection. In addition, the touch pad 1 (or the touch pad 101) may include an electrode to serve as a detection electrode other than the first electrodes 25a and the second electrodes 26a, and may use the first electrodes 25a and the second electrodes 26a as drive electrodes.

In addition, in an embodiment of the present invention, the antenna 28 (or the antenna 128) may have a shape other than the above-mentioned shapes. If being able to realize a predetermined communication function, the antenna 28 (or the antenna 128) may be, for example, a linear antenna extended in a direction intersecting with the first direction and the second direction. In addition, the antenna 28 (or the antenna 128) may be a coiled (spiral-coil-shaped) antenna wound along the external form of a rhomboid having sides extending in a direction intersecting with the first direction and the second direction.

In addition, in an embodiment of the present invention, the antenna 28 (or the antenna 128) may be arranged on the lower side of the substrate 20 (or the substrate 120) after being formed in a sheet-like member different from the substrate 20 (or the substrate 120). In addition, a magnetic sheet for suppressing the influence of a magnetic field on the main body of the electronic device 50, a supporting plate for supporting the touch pad 1 from below, or the like may be arranged on the lower side of the antenna 28 (or the antenna 128).

What is claimed is:

1. A touch pad with an antenna comprising:
a substrate on an upper side of having set thereon an operation surface having a predetermined operation region;
an electrode group that detects capacitance arranged in a region of the substrate corresponding to the operation region; and
an antenna for wireless communication arranged in a region located on a lower side of the substrate, the region overlapping with an electrode group forming region in which the electrode group for detecting capacitance is disposed, as viewed from above, wherein
the electrode group for detecting capacitance includes a first electrode group extended in a predetermined first direction and a second electrode group extended in a second direction perpendicular to the first direction, and
wherein the antenna is extended in a direction intersecting with the first direction and the second direction.

2. The touch pad with an antenna according to claim 1, wherein
the antenna comprises a coiled antenna wound along an outer circumference of a circle.

3. The touch pad with an antenna according to claim 1, wherein
the operation region is a rectangular-shaped region having a long side extending in the first direction and a short side extending in the second direction, and
the antenna comprises a coiled antenna wound along an outer circumference of an ellipse having a long axis extending in the first direction and a short axis extending in the second direction.

4. The touch pad with an antenna according to claim 1, wherein
a ground electrode made of a conductive material is arranged at a position, located on a lower side of the electrode group for detecting capacitance and located on an upper side of the antenna, so as to overlap with a whole region of the electrode forming region as viewed from above, and
a plurality of slits are formed in the ground electrode so as to radially extend from the vicinity of a central portion of the ground electrode.

5. The touch pad with an antenna according to claim 4, wherein
the slits are arranged at regular intervals with respect to a rotation direction centered at the central portion of the ground electrode.

6. The touch pad with an antenna according to claim 4, wherein
the slits are formed so as to divide an outer periphery portion of the ground electrode.

7. The touch pad with an antenna according to claim 4, wherein
the ground electrode includes a linking portion configured to link a plurality of ground electrode patterns divided by the slits, in the central portion of the ground electrode.
